(19) United States
(12) Patent Application Publication
(10) Pub. No.: US 2005/0252052 A1
(43) Pub. Date: Nov. 17, 2005

(54) Simulated fish scale decoration

(76) Inventor: Chun-Ching Liao, Feng-Yuan City (TW)

Correspondence Address: LADAS & PARRY, 26 West 61st Street, New York, NY, 10023-7604, US

(21) Appl. No.: 10/843,022

(22) Filed: May 11, 2004

(51) Int. Cl. G09F 1/08

(52) U.S. Cl. 40/538

(57) ABSTRACT

A simulated fish scale decoration includes a frame, a screen member mounted on the frame, and a plurality of bright pieces which are connected to the screen member and which overlap one another to form a fish scale simulation. The frame includes a plurality of elongated supporting posts which are spaced apart vertically and which are transverse to a vertical line.

### BACKGROUND OF THE INVENTION

1. Field of the Invention

The invention relates to a decorative device, more particularly to a simulated fish scale decoration.

2. Description of the Related Art

A conventional external decoration usually uses materials, such as oil paint, tiles, plastic boards, metal boards, or glasses, applied directly to a wall surface. However, the resulting effect is dull and monotonous. Furthermore, when the oil paint or tiles are used for decoration, the decorating procedure involves a large amount of time and labor, and alteration of the decoration, if desired, is complicated. When the board or plate materials are used, these materials cannot be disposed smoothly on the wall surface if the latter is rough. In case the wall surface is relatively large, the board or plate materials needed will be relatively large and heavy, which in turn will adversely affect transport and installation of the same. Removal of the board or plate materials for replacement is also relatively inconvenient. Moreover, since the aforementioned materials are directly adhered on the wall surface, they provide limited heat-insulation effect.

A conventional signboard usually includes an iron frame and a layer of iron sheet covering the iron frame. The iron sheet is sprayed or engraved with letters. After the signboard is installed, the resulting effect is dull and unattractive. If the signboard is large, installation and transport of the same are relatively troublesome.

### SUMMARY OF THE INVENTION

Therefore, the object of the present invention is to provide a simulated fish scale decoration that can be easily installed and transported, that can provide good heat-insulation effect, that can reflect light so as to be attractive, and that can be assembled and altered easily as desired.

According to this invention, a simulated fish scale decoration comprises a frame, a screen member mounted on the frame, and a plurality of bright pieces which are connected to the screen member and which overlap one another to form a fish scale simulation.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a preferred embodiment of a simulated fish scale decoration according to the present invention in a state of use;

FIG. 2 is an exploded perspective view of the preferred embodiment of FIG. 1;

FIG. 3 is a partly sectional schematic side view of the preferred embodiment of FIG. 1 in an assembled state;

FIG. 4 is a schematic view of another embodiment of a simulated fish scale decoration according to the present invention;

FIG. 4A is partly sectional schematic side view of FIG. 4;

FIG. 5 is a schematic view of still another embodiment of a simulated fish scale decoration according to the present invention;

FIG. 5A is partly sectional schematic side view of FIG. 5;

FIG. 6 is a partly sectional schematic side view of a further embodiment of a simulated fish scale decoration according to the present invention; and

FIG. 7 illustrates a modified bright piece of a simulated fish scale decoration according to the present invention.

### DETAILED DESCRIPTION OF THE PREFERRED EMBODIMENTS

Before the present invention is described in greater detail, it should be noted that like elements are denoted by the same reference numerals throughout the disclosure.

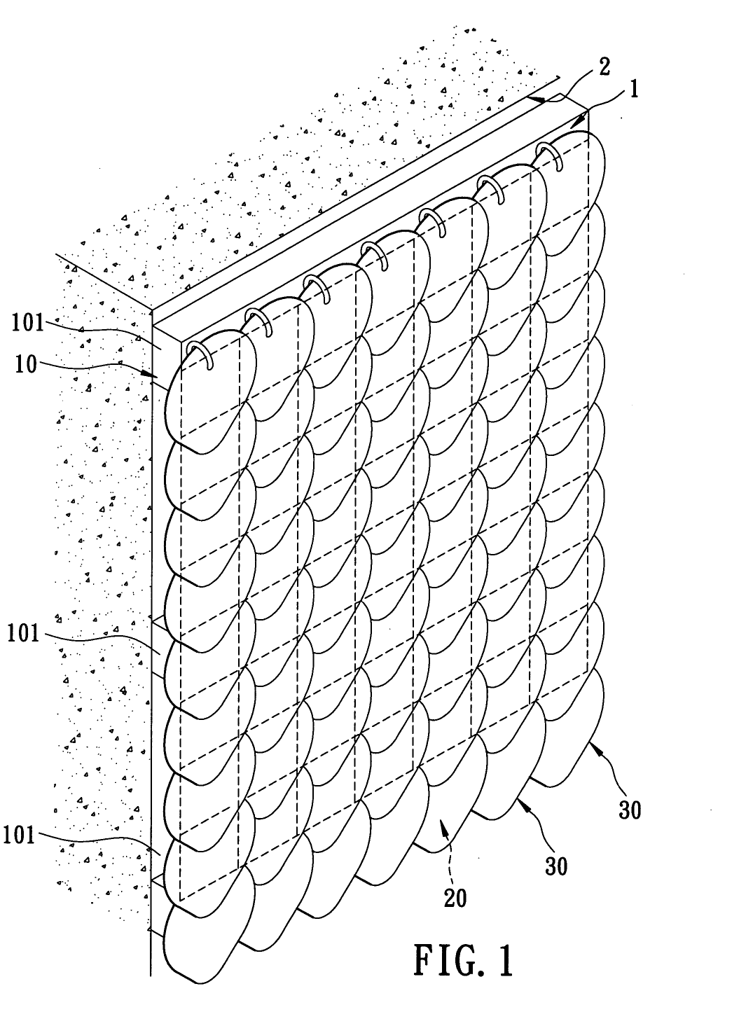

Referring to FIGS. 1, 2 and 3, a preferred embodiment of a simulated fish scale decoration 1 according to the present invention is adapted to be disposed on a wall surface 2, and is shown to comprise a frame 10, a screen member 20, and a plurality of bright pieces 30.

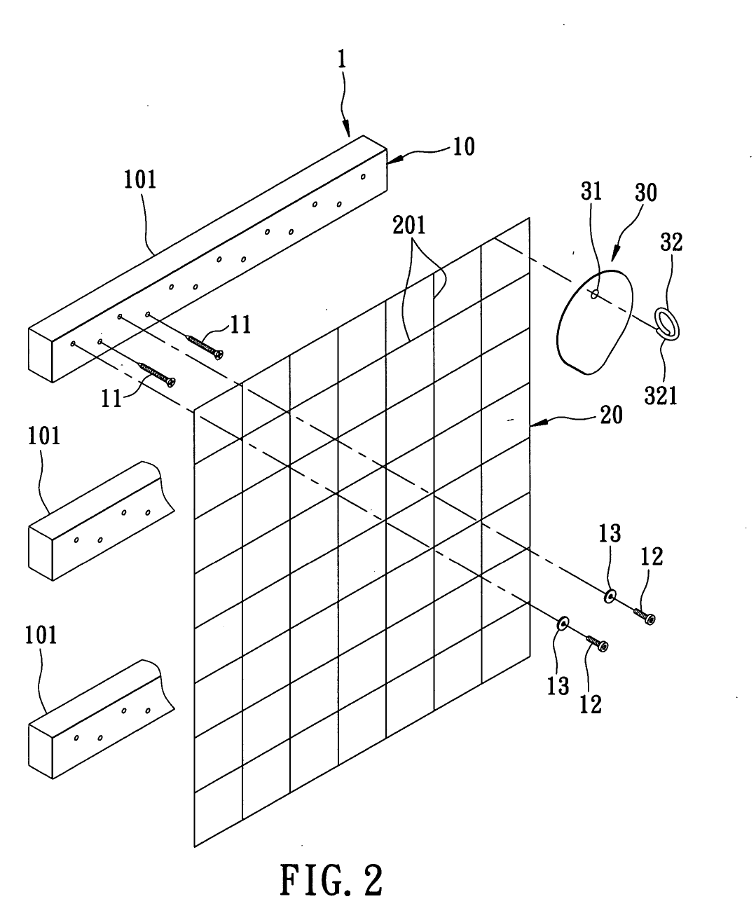

The frame 10 includes three elongated supporting posts 101 which are spaced apart vertically and which are transverse to a vertical line. A plurality of cross head screws 11 (only two are shown in FIG. 2) are used to mount the supporting posts 101 on the wall surface 2. However, nails (not shown) can be used instead of the cross head screws 11.

The screen member 20 is flexible, and may be made of metal. The screen member 20 is secured on the supporting posts 101 by means of a plurality of bolts 12 (only two are shown in FIG. 2) and a plurality of packing rings 13 (only two are shown in FIG. 2) sleeved respectively on the bolts 12 so as to press the screen member 20 against the supporting posts 101 when the bolts 12 engage the supporting posts 101. The screen member 20 is spaced apart from the wall surface 2 to effect air circulation, and includes a plurality of intersecting wires 201.

Each of the bright pieces 30 is oval, and has a shiny face. Each bright piece 30 includes a through hole 31 and a hooking ring 32. The hooking ring 32 includes a wire-like member 321 extending through the through hole 31 and looped around one of the intersecting wires 201 of the screen member 20 so as to form a ring and so as to hang the respective bright piece 30 on the screen member 20. When a wind blows, the bright pieces 30 can produce swaying motion. The hooking ring 32 is openable so as to form an aperture to facilitate removal and replacement of the bright pieces 30. The bright pieces 30 overlap one another on the screen member 20 so as to form a fish scale simulation, thereby covering the screen member 20. Each of the bright pieces 30 is made of a material selected from the group consisting of metal, plastic, glass, ceramic, wood, paper, and shell. Each of the bright pieces 30 can be made of different materials to provide variety. Each bright piece 30 can be further provided with a coating layer by means of electroplating, spray coating, or printing so as to coat one or more colors on the surface of each bright piece 30.

The simulated fish scale decoration 1 of the present invention is relatively easy to assemble. The bright pieces 30 can be hung on the screen member 20 while in the factory or on the spot. Then, the supporting posts 101 are fixed on the wall surface 2, after which the assembly of the screen member 20 and the bright pieces 30 is fixed on the supporting posts 101 through the bolts 12 and the packing rings 13. The bolts 12, the packing rings 13, and the screen member 20 are covered by the bright pieces 30 at this time.

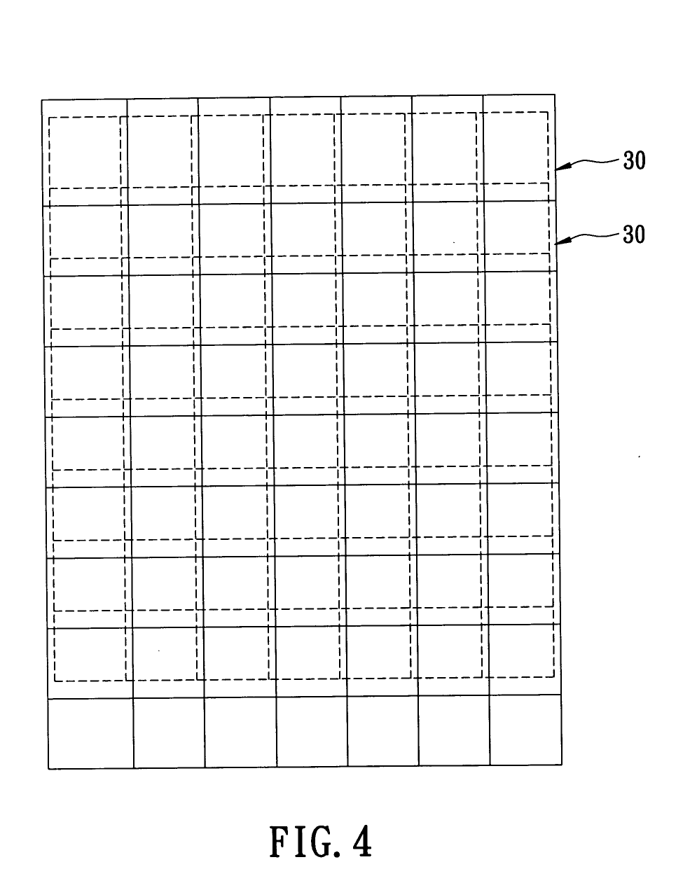

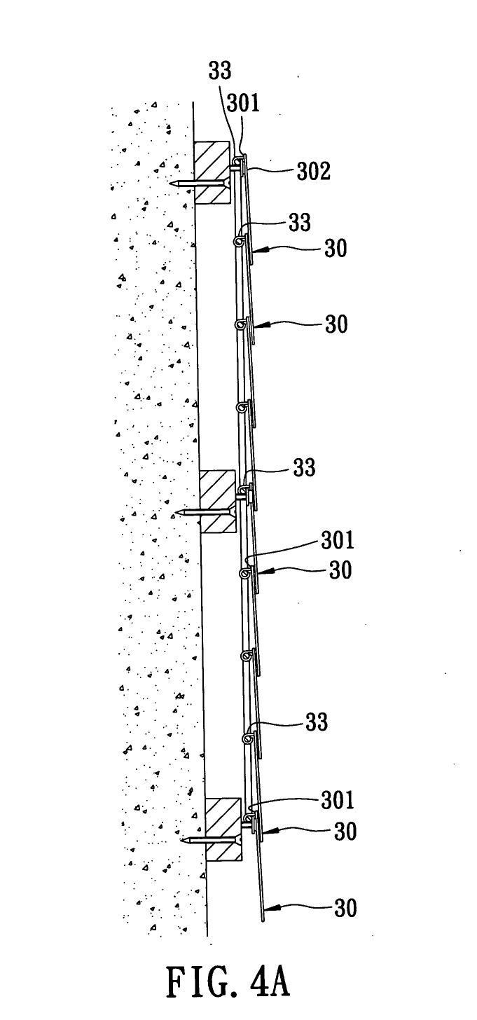

In another embodiment of the present invention, as shown in FIGS. 4 and 4A, the bright pieces 30 are formed as a rectangular shape, and each of the bright pieces 30 has a back side 301 facing the screen member 20, a front side 302 opposite to the back side 301, and a hook portion 33 attached adhesively to the back side 301. As such, the hook portion 33 is not exposed at the front side 302 of the respective bright piece 30, thereby enhancing the appearance of the whole assembly of the simulated fish scale decoration 1 of the present invention.

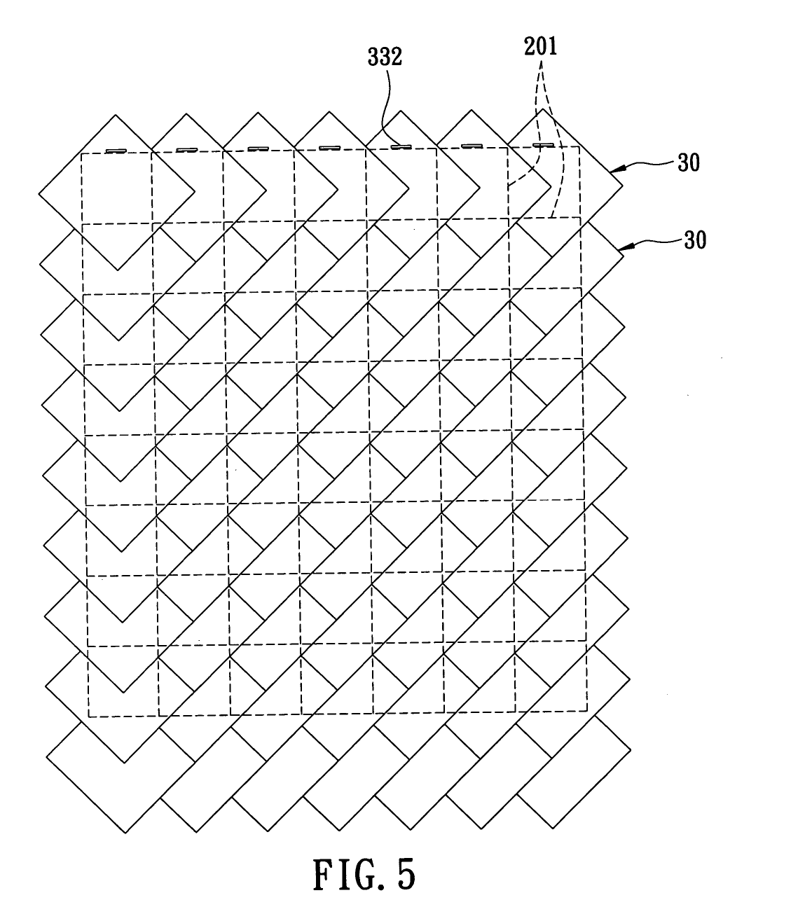

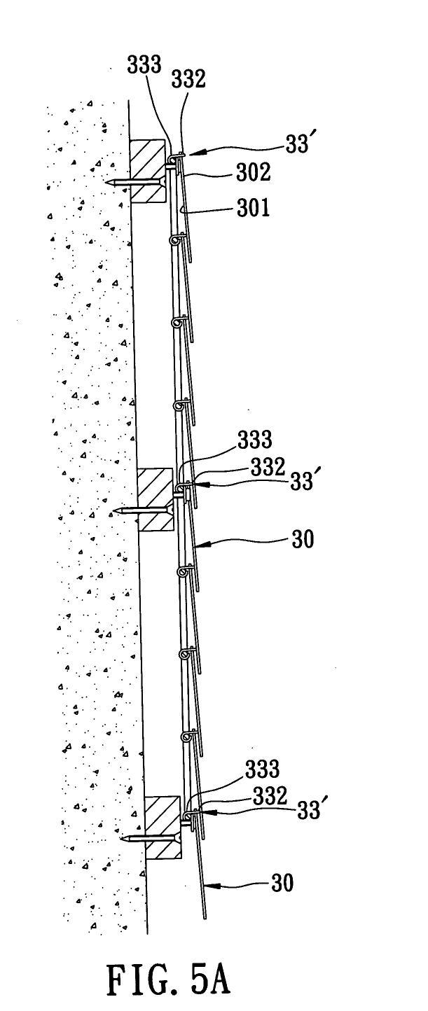

In still another embodiment of the present invention, as shown in FIGS. 5 and 5A, the bright pieces 30 are formed as a rhombic shape, and each of the bright pieces 30 has a back side 301 and a front side 302 opposite to the back side 301, and includes a through hole 31, and a hook portion 33′ that has a head 332 and a hooking tail 333. During assembly, the hooking tail 333 is extended through the through hole 31 in the respective bright piece 30, and is hung on one of the intersecting wires 201. At this time, the head 332 abuts against the front side 302 of the respective bright piece 30. Thus, assembly of this embodiment is also relatively easy.

Through a combination of different shapes, materials, and colors of the bright pieces 30, a different style of decoration can be effected. Furthermore, each of the bright pieces 30 can have a concave face, a convex face, or a face formed with a relief so that light refractive points can be increased and brightness can be enhanced.

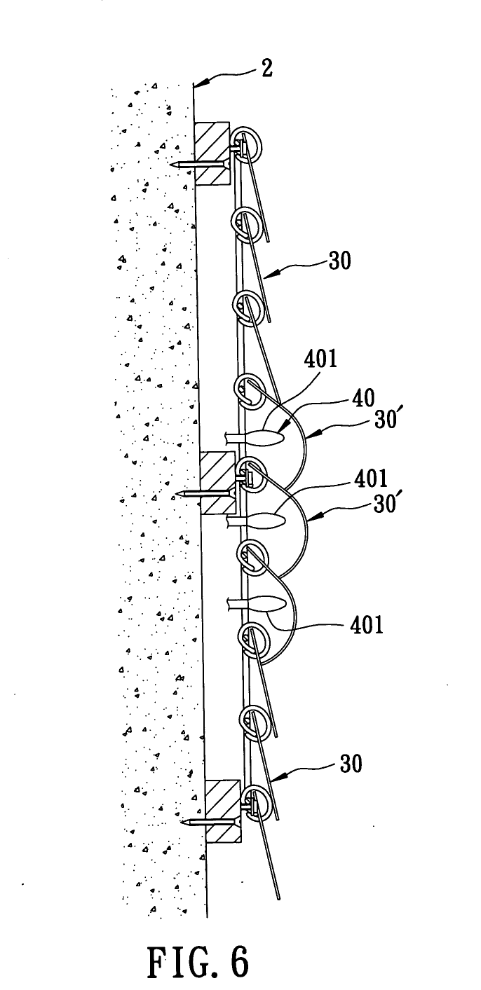

The simulated fish scale decoration 1 of the present invention may further comprise a lighting unit 40 mounted on the screen member 20. In particular, as shown in FIG. 6, there are first and second bright pieces 30, 30′. The second bright pieces 30′ are convex, are made of glass, and are disposed at a central portion of the screen member 20 in such a manner that they form a pattern consisting of letters or pictures. As the second bright pieces 30′ are convex and the first bright pieces 30 are flat, a relief pattern is formed by the second bright pieces 30′. The lighting unit 40 includes a plurality of lighting elements 401 (only three are shown in FIG. 6), such as light emitting diodes (LED). The lighting elements 401 are covered respectively by the second bright pieces 30′, and are disposed between the respective second bright piece 30′ and the wall surface 2. Through flashing and changing of colors of the lighting elements 401, a variety of colors are radiated through the glass-made second bright pieces 30′ so as to effect a more attractive simulated fish scale decoration 1.

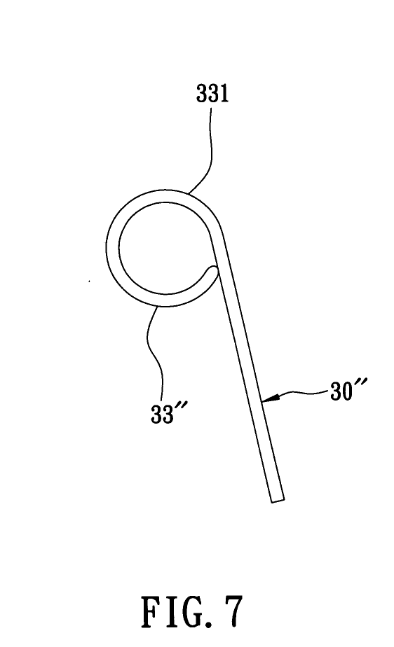

Referring to FIG. 7, a modified bright piece 30″ is shown to have an integrally formed wire-like hook portion 33″. The hook portion 33″ may be attached to one of the intersecting wires 201 (see FIG. 2) of the screen member 20 (see FIG. 2) and may be looped around one of the intersecting wires 201 so as to form a ring, like the hooking ring 32 shown in FIG. 2.

The advantages of the present invention can be summarized as follows:

1. When assembling the present invention on the spot, the supporting posts 101 are secured on the wall surface 2, and the screen member 20 is secured on the supporting posts 101 such that the installation is relatively simple and quick. When alteration of the decoration is desired, the assembly of the screen member 20 and the bright pieces 30, 30′ is simply removed from the supporting posts 101, and is replaced with another assembly of the screen member 20 and the bright pieces 30, 30′.

2. When some of the bright pieces 30, 30′ are damaged, the defective bright pieces 30, 30′ can be individually removed for replacement such that the simulated fish scale decoration 1 is relatively easy to maintain.

3. The screen member 20 of the present invention can be rolled as well as the bright pieces 30 that are hung on the screen member 20 so that transport of the simulated fish scale decoration 1 is relatively convenient and so that the storage space for the simulated fish scale decoration 1 is reduced.

4. Since the screen member 20 of the present invention can be rolled, the present invention can be suitably used on different surfaces, such as a post surface, a truck body, etc., and even on objects with curved or protruding portions.

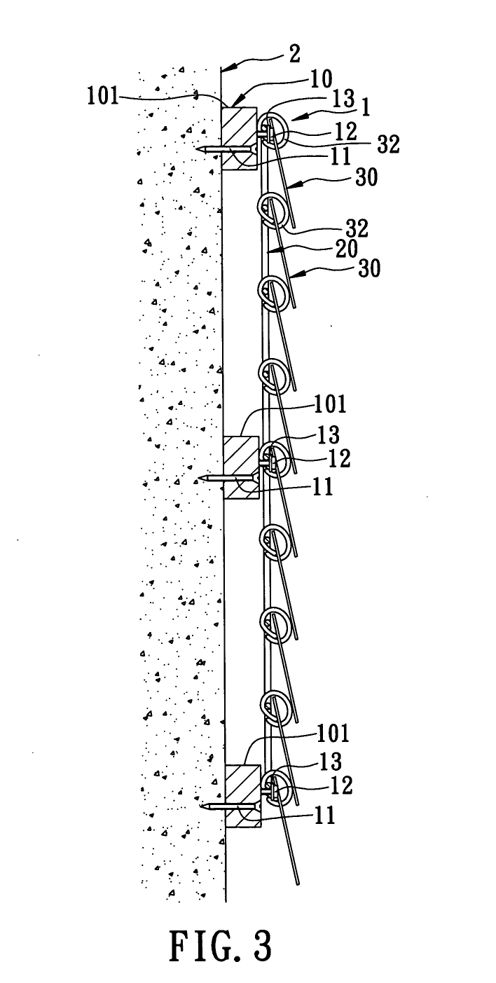

5. Since the screen member 20 is spaced apart from the wall surface 2, as best shown in FIGS. 3 and 6, circulation of air can be maintained so that the wall surface 2 can quickly dissipate heat. The bright pieces 30, 30′ can reflect and refract light rays so as to block the light rays and so that the light rays cannot directly reach the wall surface 2. As such, the heat insulating effect of the present invention is relatively good, thereby maintaining a cool atmosphere within a room.

6. Since the bright pieces 30, 30′ can reflect and refract light rays, and since the bright pieces 30, 30′ can produce swaying by the blowing of the wind, the bright pieces 30, 30′ can shine brightly, thereby producing a colorful sight that can draw one's attention. Thus, when the simulated fish scale decoration 1 is used for advertising, it will have a very good effect.

7. Since different shapes, materials and colors of the bright pieces 30 can be combined, and since the installation and replacement of the bright pieces 30 are relatively simple, the user can mix and match the bright pieces 30 as desired. At the same time, through the pattern formed by the different bright pieces 30, 30′, or direct application of a coating on the bright pieces 30, 30′, advertising effect is achieved.

Additionally, it should be noted that the screen member 20 can be made of plastic or cloth material. However, the plastic or cloth material has poor fireproofing effect, and is not durable.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A simulated fish scale decoration comprising:
a frame;
a screen member mounted on said frame; and
a plurality of bright pieces which are connected to said screen member and which overlap one another to form a fish scale simulation.

2. The simulated fish scale decoration as claimed in claim 1, wherein said frame includes a plurality of elongated supporting posts which are spaced apart vertically and which are transverse to a vertical line.

3. The simulated fish scale decoration as claimed in claim 1, wherein said screen member is flexible, said screen member including a plurality of intersecting wires, each of said bright pieces being hung on one of said intersecting wires.

4. The simulated fish scale decoration as claimed in claim 3, wherein each of said bright pieces includes a through hole and a hooking ring which has a wire-like member that is looped to form a ring and that is openable to form an aperture, said wire-like member extending through said through hole and being hung on one of said intersecting wires.

5. The simulated fish scale decoration as claimed in claim 3, wherein each of said bright pieces has an integrally formed wire-like hook portion attached to one of said intersecting wires and which is looped to form a ring and which is openable to form an aperture.

6. The simulated fish scale decoration as claimed in claim 3, wherein each of said bright pieces has a back side facing said screen member, and a hook portion attached adhesively to said back side and hung on one of said intersecting wires.

7. The simulated fish scale decoration as claimed in claim 3, wherein each of said bright pieces has a back side and a front side opposite to said back side, and includes a through hole and a hook portion that has a head abutting against said front side, and a hooking tail extending through said through hole and hung on one of said intersecting wires.

8. The simulated fish scale decoration as claimed in claim 1, wherein each of said bright pieces is made of a material selected from the group consisting of metal, plastic, glass, ceramic, wood, paper, and shell.

9. The simulated fish scale decoration as claimed in claim 1, wherein each of said bright pieces is provided with a coating layer.

10. The simulated fish scale decoration as claimed in claim 1, wherein each of said bright pieces is convex.

11. The simulated fish scale decoration as claimed in claim 1, wherein each of said bright pieces is concave.

12. The simulated fish scale decoration as claimed in claim 1, wherein each of said bright pieces is formed with a relief.

13. The simulated fish scale decoration as claimed in claim 1, further comprising a lighting element mounted on said screen member to lighten said bright pieces, each of said bright pieces being made of glass.

14. The simulated fish scale decoration as claimed in claim 1, wherein each of said bright pieces is oval.

15. The simulated fish scale decoration as claimed in claim 1, wherein each of said bright pieces is rectangular.

16. The simulated fish scale decoration as claimed in claim 1, wherein each of said bright pieces is rhombic.

17. The simulated fish scale decoration as claimed in claim 1, wherein said bright pieces include first bright pieces and second bright pieces, said first bright pieces being substantially flat, said second bright pieces being substantially convex and forming a relief pattern among said first bright pieces.

18. The simulated fish scale decoration as claimed in claim 17, further comprising a plurality of lighting elements mounted on said screen member to lighten respectively said second bright pieces.

19. The simulated fish scale decoration as claimed in claim 2, wherein said screen member is clamped against said supporting posts.
